(19) United States
(12) Patent Application Publication
(10) Pub. No.: US 2009/0192947 A1
(43) Pub. Date: Jul. 30, 2009

(54) Generating a Savings Plan

(75) Inventors: Matthew B. Kenigsberg, Hingham, MA (US); Glenn Larsen, Norton, MA (US); Ashish Mehta, Bangalore (IN)

Correspondence Address: Patent Administrator;Proskauer Rose LLP, One International Place, Boston, MA, 02110-2600, US

(73) Assignee: FMR LLC, Boston, MA (US)

(21) Appl. No.: 12/019,201

(22) Filed: Jan. 24, 2008

(51) Int. Cl. G06Q 40/00

(52) U.S. Cl. 705/36 R

(57) ABSTRACT

A user utilizing a user interface inputs debt information, income information and savings information. The user also inputs retirement information which includes aspects of the user's retirement plans (e.g., age of retirement, current age, etc.). The debt information, the income information, and the savings information are assigned to categories. The categories are prioritized to generate a savings plan that includes a savings prioritization (e.g., save into these types of accounts in this order) and/or a spending prioritization (e.g., spend from these types of accounts in this order). The savings plan and/or a quantified benefit of its use is displayed to the user.

### FIELD OF THE INVENTION

The present invention relates generally to computer-based methods and apparatuses, including computer program products, for generating a savings plan.

### BACKGROUND

Individuals save and spend from a variety of accounts and types of accounts. There are a variety of savings strategies that are generally recommended by financial advisors for these accounts. For example, a commonly held view holds that an individual should always pay off his/her credit card accounts first, and then the individual should contribute to his/her retirement account. These generic savings strategies work to a varying degree among individuals, but they are static and meant to be applied to the average individual. It is difficult, if not impossible, to have a static and generic savings strategy (i.e., a one-size-fits-all approach) that benefits everyone.

### SUMMARY OF THE INVENTION

One aspect of generating a savings plan is a computerized method. The computerized method includes receiving debt information, income information, and savings information. The computerized method further includes receiving retirement information. The retirement information includes an age, a retirement age, investment criteria, and/or insurance information. The computerized method further includes assigning the debt information, the income information, and the savings information to a plurality of categories and automatically generating the savings plan by prioritizing the assigned plurality of categories based on the debt information, the income information, the savings information, and/or the retirement information.

Another aspect of generating a savings plan is a computer program product. The computer program product is tangibly embodied in an information carrier. The computer program product includes instructions being operable to cause a data processing apparatus to receive debt information, income information, and savings information. The computer program product further includes instructions being operable to cause a data processing apparatus to receive retirement information. The retirement information includes an age, a retirement age, investment criteria, and/or insurance information. The computer program product further includes instructions being operable to cause a data processing apparatus to assign the debt information, the income information, and the savings information to a plurality of categories and automatically generate the savings plan by prioritizing the assigned plurality of categories based on the debt information, the income information, the savings information, and/or the retirement information.

Another aspect of generating a saving plan is a system. The system includes a savings plan module. The savings plan module is configured to receive debt information, income information, savings information, and receive retirement information. The retirement information includes an age, a retirement age, investment criteria, and/or insurance information. The savings plan module is further configured to assign the debt information, the income information, and the savings information to a plurality of categories and automatically generate the savings plan by prioritizing the assigned plurality of categories based on the debt information, the income information, and/or the savings information.

Another aspect of generating a savings plan is a system. The system includes a means for receiving debt information, income information, savings information, and receive retirement information. The retirement information includes an age, a retirement age, investment criteria, and/or insurance information. the system further includes a means for assigning the debt information, the income information, and the savings information to a plurality of categories. The system further includes a means for automatically generating the savings plan by prioritizing the assigned plurality of categories based on the debt information, the income information, and/or the savings information.

In other examples, any of the aspects above can include one or more of the following features. A user interface is provided to enable a user to enter information. A display is generated. The display includes the savings plan.

In some examples, a current plan of the assigned plurality of categories is determined based on the debt information, the income information, and/or the savings information. A savings optimization is determined based on the savings plan and the current plan.

In other examples, a display is generated. The display includes the savings optimization. The savings optimization includes a time interval and/or an amount. A plurality of accounts are associated with the debt information, the income information, and/or the savings information. The plurality of accounts are assigned to the plurality of categories.

In some examples, in each category which includes a plurality of accounts, the plurality of accounts are prioritized within the category. A priority for each account in a first category are identical or different.

In other examples, an optimal prioritization of the assigned plurality of categories is determined based on a selection criteria. The selection criteria is determined based on retirement income amount, portfolio longevity in retirement, and/or portfolio value at retirement. The assigned plurality of categories are prioritized based on the debt information, the income information, and/or the savings information and relationships between financial properties of the assigned plurality of categories.

In some examples, the assigned plurality of categories are prioritized based on the debt information, the income information, and/or the savings information and a set of savings plans that represents all of the possible prioritizations of the plurality of categories. The optimal prioritization within the set of savings plans is determined by utilizing one or more business rules with the debt information, the income information, and/or the savings information. Each savings plan in the set of savings plans includes a prioritization, which is different from prioritizations of other savings plans in the set of savings plans. The set of savings plans includes fewer prioritizations then possible for the assigned plurality of categories.

In other examples, the set of savings plans is determined based on a client category. The client category is determined by prioritizing one or more client parameters associated with the debt information, the income information, and/or the savings information

In some examples, the debt information, the income information, and the savings information are prioritized based on the assigned plurality of categories and the savings information in each assigned category independently from other categories in the assigned plurality of categories based on the assigned plurality of categories.

In other examples, the plurality of categories includes income, taxable savings, pre-tax deferred matched savings, unsecured debt, pre-tax exempt matched savings, pre-tax exempt non-matched savings, pre-tax deferred non-matched savings, post-tax exempt savings, post-tax deferred savings, secured floating non-deductible debt, secured fixed non-deductible debt, and/or fixed rate deductible debt.

In some examples, the debt information includes a credit account, a loan account, a non-secured debt account, a secured fixed non-deductible debt account, a secured floating non-deductible debt account, a fixed deductible debt account, and/or a floating deductible debt account.

In other examples, the savings information includes a retirement account, an investment account, a pre-tax deferred savings account, a post-tax deferred savings account, a post-tax exempt savings account, a pre-tax exempt savings account, and/or any other type of savings information (e.g., pre-retirement income, post-retirement real income, post-retirement nominal income, pre-retirement lifestyle spending, post-retirement lifestyle spending, the retirement year, general inflation, pre-retirement income growth, post-retirement lifestyle inflation, and/or the client starting age).

In some examples, tax information is received. The tax information includes a tax bracket, a deduction, an effective tax rate, and/or any other type of tax information (e.g., pre- and post-retirement federal marginal income tax brackets, pre- and post-retirement state/local income tax rates, pre- and post-retirement values for tax deductions, pre- and post-retirement long-term capital gains tax rates, a value for tax management impact, a value for tax efficiency, pre- and post-retirement liquidation tax values, and/or values for pre- and post-retirement effective tax rates). An information storage module is configured to store the retirement information, the debt information, the income information, and the savings information.

An advantage to the customized savings plan is that the specific financial characteristics of an individual are incorporated, increasing the benefit of the plan. Another advantage to the customized savings plan is that the plan can change to reflect changes in the individual's financial circumstances.

An additional advantage is that a quantifiable difference between an individual's current savings plan and the proposed savings plan can be displayed to the individual which enables the user to better understand the advantage of changing his/her savings plan. Another advantage is that even small changes in the savings plans of an individual can make dramatic changes to the individual's retirement plans when the savings plan is more customized to that individual.

Other aspects and advantages of the present invention will become apparent from the following detailed description, taken in conjunction with the accompanying drawings, illustrating the principles of the invention by way of example only.

### BRIEF DESCRIPTION OF THE DRAWINGS

The foregoing and other objects, features, and advantages of the present invention, as well as the invention itself, will be more fully understood from the following description of various embodiments, when read together with the accompanying drawings.

FIG. 1 depicts an exemplary system with a financial server.

FIG. 2 depicts an exemplary flowchart of displaying an optimal savings plan.

FIG. 3 depicts an exemplary user interface of the system.

FIG. 4 depicts another exemplary user interface of the system.

FIG. 5 depicts another exemplary user interface of the system.

FIG. 6 depicts an exemplary distribution of portfolio longevity for a given individual, as determined by the system.

### DETAILED DESCRIPTION

In general overview, a user utilizing a user interface inputs debt information, income information, and savings information. The user also inputs retirement information which includes aspects of the user's retirement plans (e.g., age of retirement, current age, employment after retirement). The debt information, the income information, and the savings information are assigned to categories (e.g., savings accounts, such as taxable accounts, pre-tax deferred accounts (e.g., 401k accounts), post-tax deferred accounts (e.g., variable annuities), employer matched accounts pre-tax deferred accounts, and the like; debt accounts, such as secured fixed-rate accounts, unsecured fixed-rate accounts, unsecured floating-rate accounts, and the like, and other types of accounts where assets or liabilities can grow over time in some deterministic or modeled way). The categories are prioritized to generate a savings plan that includes a savings prioritization (e.g., save into these types of accounts in this order) and/or a spending prioritization (e.g., spend from these types of accounts in this order). The savings plan is displayed to the user.

For example, five categories of accounts—pre-tax deferred unmatched, pre-tax deferred matched, post-tax deferred unmatched, post-tax deferred matched, and fixed secured debt—are associated with John Smith. The categories are prioritized based on the debt information, the income information, the savings information, and the retirement information. The savings prioritization for Mr. Smith is pre-tax deferred matched, post-tax deferred unmatched, post-tax deferred matched, pre-tax deferred unmatched, and fixed-rate secured debt (e.g., save into savings/debt in this order). This savings prioritization is based on the retirement information that Mr. Smith wants to retire in five years. The spending prioritization for Mr. Smith is pre-tax deferred then post-tax deferred (e.g., spend from savings in this order). The other three categories are not included here since assets cannot be removed from those categories of accounts in this example.

As another example, Allen Taylor wants to retire in twenty years and his savings prioritization for the same categories as described above is pre-tax deferred matched, pre-tax deferred unmatched, post-tax deferred matched, post-tax deferred unmatched, and fixed-rate secured debt. The techniques described herein calculate the savings plan for Allen Taylor based on his individual information (e.g., interest rates of his savings and debt accounts), which could result in a different savings plan than the one determined for Mr. Smith. An advantage is that the savings plan (e.g., savings prioritization and spending prioritization) is based on the account information and quantifiable needs of the user (e.g., Mr. Taylor's interest rates and his plan to retire in ten years).

### Savings Plan Generation

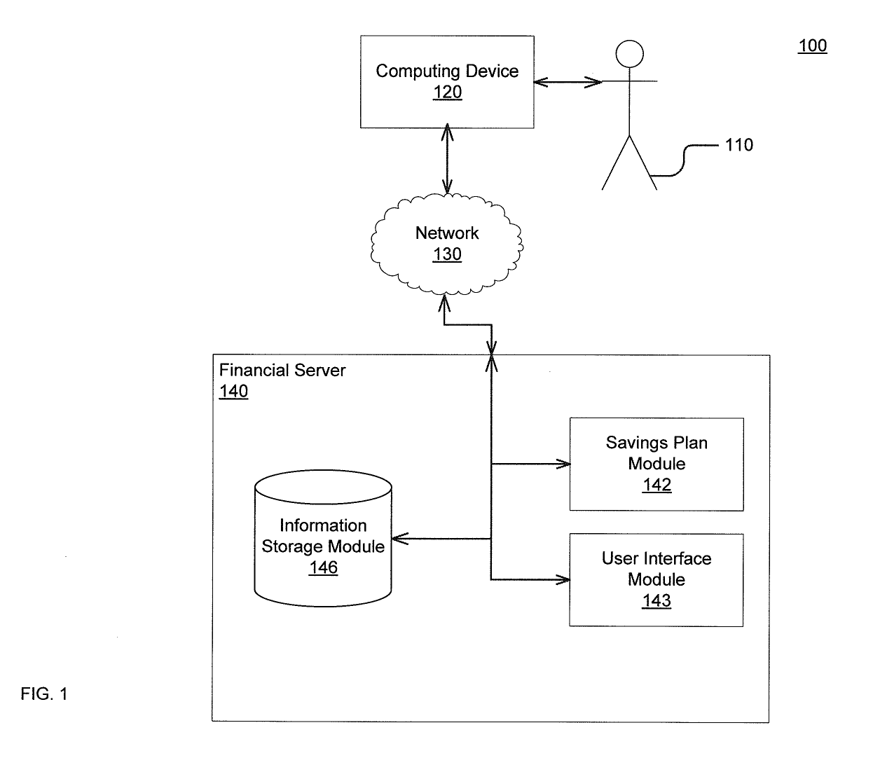

FIG. 1 depicts an exemplary system 100 used to generate a savings plan. The system 100 includes a computing device 120, a communications network 130, and a financial server 140. The financial server 140 includes a savings plan module 142, a user interface module 143, and an information storage module 146.

A user 110 utilizes the computing device 120 (e.g., laptop, personal digital assistant) of the system 100 to access a user interface associated with the financial server 140 to input information associated with the user 110 and/or a consumer (e.g., where a representative is entering data and using the system to generate a savings plan for a consumer). The user interface is generated by the user interface module 143. The information is transmitted through the communications network 130 (e.g., internet, local area network, etc) to the financial server 140.

The savings plan module 142 receives the information (e.g., debt information, income information, savings information, retirement information). The savings plan module 142 assigns the information into a plurality of categories. The savings plan module 142 generates a savings plan by prioritizing the assigned categories based on the information. The information storage module 146 stores information associated with retirement and information associated with debt, income, and/or savings. Although shown as a single module, the information storage module 146 can include a plurality of storage devices physically and/or logically separate from each other. Similarly, the savings plan module 142 and user interface module 143 can be combined into a single module that performs both functions.

The savings plan can include, for example, a savings prioritization and/or a spending prioritization. Each prioritization can also, for example, be referred to as a hierarchy. The savings prioritization can provide, for example, a sequence of categories to save to (e.g., pre-tax matched savings, post-tax matched savings) and/or pay down (e.g., revolving unsecured debt, fixed deductible debt). The spending prioritization can provide, for example, a sequence of categories to spend from (e.g., taxable savings, pre-tax deferred savings). An advantage of the spending prioritization is that the prioritization can illustrate to the user 110 how to spend the funds once the user 110 begins retirement.

The savings plan can include, for example, a plurality of accounts with funds (e.g., 401K account, bank savings account) and/or debts (e.g., credit card account, home mortgage account). The savings plan can include, for example, the savings prioritization which describes the priority for increasing the amount of savings and/or to decreasing the amount of debt (i.e., paying off the debt) in an account. The savings plan can include, for example, the spending prioritization which describes the priority for decreasing the amount of savings (i.e., using the funds in a savings account).

An exemplary savings plan generated by the savings plan module 142 is illustrated in Tables 1 and 2. Table 1 illustrates an exemplary savings prioritization and Table 2 illustrates an exemplary spending prioritization.

TABLE 1
Savings Prioritization

| Priority | Category |
|---|---|
| 1 | Pre-tax deferred matched savings |
| 2 | Pre-tax exempt matched savings |
| 3 | Post-tax exempt savings |
| 4 | Fixed rate deductable debt |
| 5 | Secured floating non-deductable debt |
| 6 | Pre-tax deferred non-matched savings |
| 7 | Unsecured debt |
| 8 | Taxable savings |
| 9 | Pre-tax exempt non-matched savings |
| 10 | Post-tax deferred savings |
| 11 | Secured fixed non-deductible debt |
| 12 | Floating rate deductible debt |

TABLE 2
Spending Prioritization

| Priority | Category |
|---|---|
| 1 | Pre-tax exempt savings |
| 2 | Pre-tax deferred savings |
| 3 | Taxable savings |
| 4 | Post-tax exempt savings |
| 5 | Post-tax deferred savings |

The user interface module 143 generates a display which includes the spending plan. The display is transmitted to the computing device 120 and displayed for the user 110. Tables 1-2 illustrate parts of an exemplary user interface displayed to the user 110. Tables 1-2 can be integrated into the user interface and/or can be displayed as pop-up displays to the user interface.

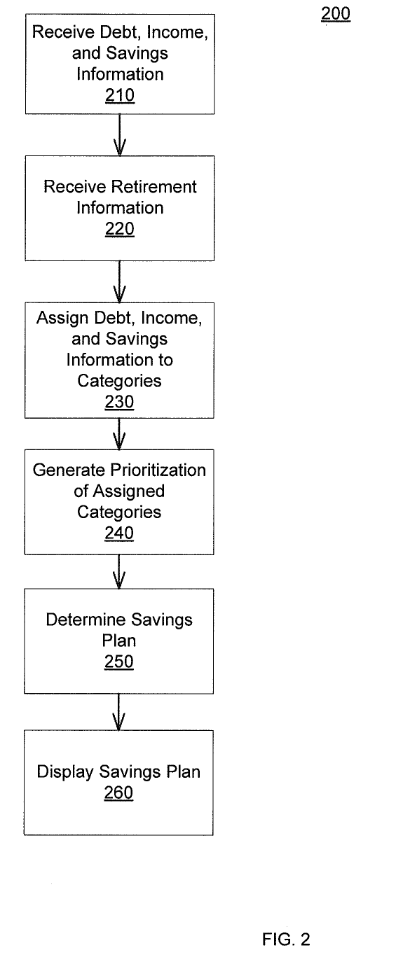

FIG. 2 depicts an exemplary flowchart 200 of displaying a savings plan through the system 100 of FIG. 1. The user interface module 143 receives (210) the debt information, the income information, and the savings information. The user interface module 143 receives (220) the retirement information. The savings plan module 142 assigns (230) the debt information, the income information, and the savings information to a plurality of categories.

The savings plan module 142 generates (240) a prioritization of the categories. Prioritizations can be determined utilizing a variety of techniques as described in more detail below. The prioritizations of the categories include, for example, the different sequences (priorities) of the categories. Tables 1 and 2 illustrate one particular sequence of the categories for the savings prioritization and the spending prioritization, respectively. Other sequences of the categories (i.e., plurality of prioritizations) can be generated (240). The plurality of prioritizations can be utilized by the savings plan module 142 to determine (250) the savings plan for the user.

The savings plan module determines (250) the savings plan by utilizing one or more prioritization techniques as described below. The savings plan module 142 transmits the savings plan to the user interface module 143 which displays (270) the savings plan to the user 110.

For example, the savings plan module 142 generates (240) a plurality of prioritizations (in this example, a plurality of spending prioritizations and a plurality of savings prioritizations) utilizing the isolate and test technique described below and then the savings plan module 142 determines (250) a particular savings plan from the plurality of prioritizations (e.g., the savings plan to be displayed (260) to the user) by utilizing the formulaic techniques described below. As another example, the savings plan module 142 generates (240) a single prioritization of the spending categories and a single prioritization of the savings categories utilizing a prioritization technique described below. The savings plan module 142 then determines (250) the savings plan by combining the single generated spending prioritization and the single generated savings prioritization. In this example, the two generated prioritizations (the spending and savings prioritizations, which are the plurality of prioritizations) are combined to make up the savings plan.

### Exemplary User Interfaces

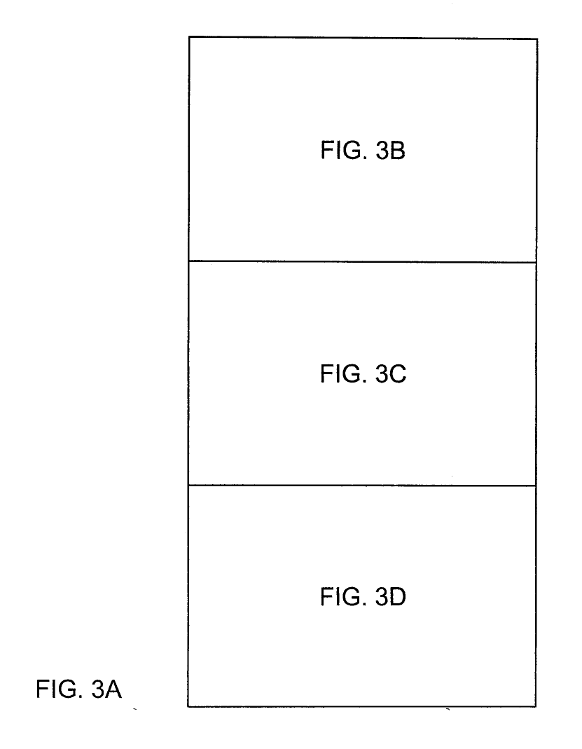

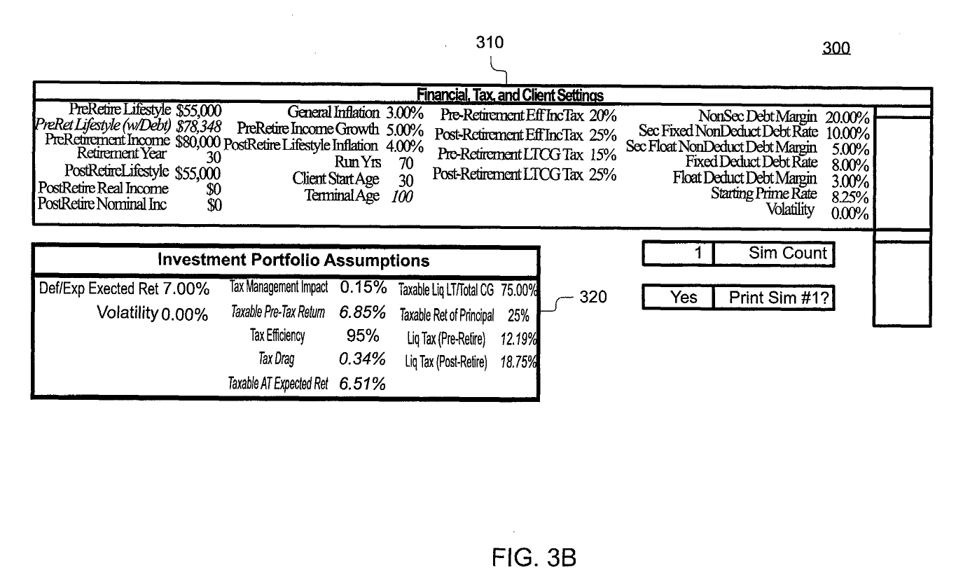

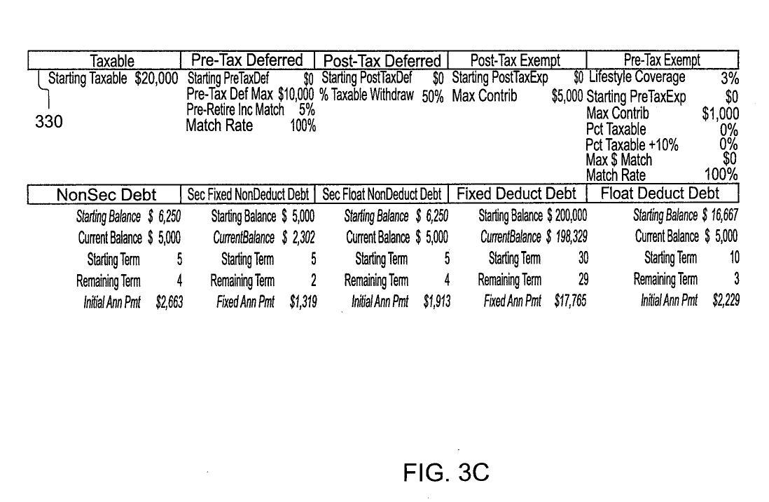

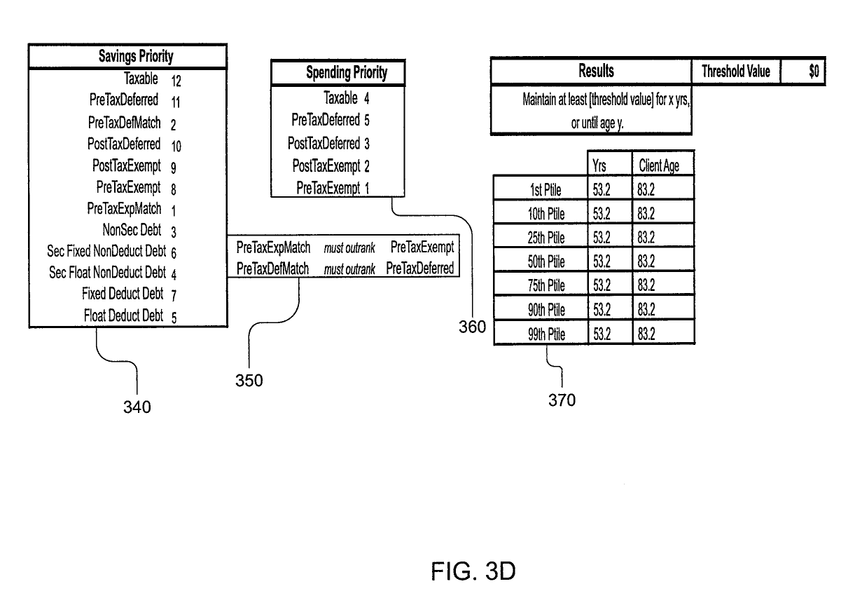

FIG. 3 depicts an exemplary user interface 300 of the system 100 of FIG. 1. The user interface 300 is generated by the user interface module 143. The user interface 300 includes financial information 310, investment information 320, category information 330, savings priority 340, savings priority information 350, spending priority 360, and results of the savings plan 370.

The financial information 310 includes the user's financial, tax, and personal information as illustrated by the area of the financial information 410 in the user interface 300. The financial information 310 also includes retirement lifestyle, retirement years, retirement tax rate, interest rates for the accounts and/or categories, and/or other information associated with the user's finances.

The investment information 320 includes information about the user's portfolio as illustrated by the area of the investment information 320 in the user interface 300. The category information 330 includes a balance for each category, a match for each of the applicable categories, a maximum contribution for each of the applicable categories, a payment for each of the applicable categories, an interest rate for each of the applicable categories, term data of the applicable categories, annual payment data of the applicable categories, and/or other information about each category as illustrated by the area of the category information 330 in the user interface 300.

The savings priority 340 illustrates a prioritization of the categories for the user associated with the information illustrated by the user interface 300. The savings priority information 350 includes information detailing any specific rules for the savings prioritization (in this example, the pre-tax deferred match category must outrank the pre-tax deferred unmatched category).

These specific rules for the savings prioritization, which are a function of the individual's financial circumstances, can be based on restrictions or preferences that make a given category certain to rank below others in a savings hierarchy. For example, it is generally impossible, and would in any case be undesirable, to contribute savings to a Pre-Tax Deferred account without employer matching (such as a 401k) before contributing to a similar account with employer matching if one is available.

The spending priority 360 includes the prioritization of how the categories should be spent. For example, the spending priority 360 indicates that funds should be withdrawn in the order of pre-tax exempt savings, post-tax exempt savings, post-tax deferred savings, taxable savings, and then pre-tax deferred savings. The results of the savings priority 370 illustrates the age of the client (e.g., user 110, third party) at which time the client will use all of his/her retirement money.

Although not shown in the savings priority 370, in other examples, the results of the savings priority are different based on the percentiles of the volatility of the financial market. For example, if the financial market is below average during retirement (e.g., 10th percentile), then the number of years can be less (e.g., 32.3 years). As another example, if the financial market is above average during retirement (e.g., 90th percentile), then the number of years can be higher (e.g., 63.2 years).

In another example, the system 100 of FIG. 1 and the user interface 300 of FIG. 3 are used with the process 200 of FIG. 2. In this example, the user 110 utilizing the user interface 300 inputs the financial information 310 (e.g., client start age, terminal age, retirement year, etc), the investment information 320 (e.g., taxable pre-tax return, management impact, etc.), and the category information 330 (in this example, this information includes the debt information (e.g., starting balance, current balance, starting term, remaining term, payment, etc.), the savings information (e.g., starting balance, match rate, maximum contribution, etc.), and the income information (e.g., income amount, etc.). The user interface module 143 receives (210) the debt information, the savings information, and the income information inputted by the user 110 utilizing the user interface 300. The user interface module 142 further receives (220) the retirement information from the user interface 300 (in this example, the retirement information is illustrated in the financial information in area 310 (e.g., retirement year 30, post retirement lifestyle $55,000, etc.).

The savings plan module 142 assigns (230) the debt information, the savings information and the income information to a plurality of categories which are defined by the category information 330. For example, the user's home mortgage information (in this example, part of the debt information) with a starting balance of $200,000, a current balance of $198,329, etc. is assigned to the fixed deductible debt category. As another example, the user's Roth IRA information (in this example, part of the savings information) with a starting balance of $0, a maximum contribution of $5,000, etc. is assigned to the post-tax exempt category. As another example, the user's 401K information (in this example, part of the savings information), the starting balance of $0, the maximum of $10,000, matching amount of 5%, etc is assigned to the pre-tax deferred category. As an additional example, the user's current salary (in this example, part of the financial information) with an amount of $80,000, etc. is assigned to the Pre-Retirement Income category. The other information as illustrated in the user interface 300 can be utilized to assign the debt information, the savings information, and the income information to the plurality of categories.

The savings plan module 142 generates (240) a prioritization of the plurality of categories based on the debt information, the savings information, the income information, and the retirement information. The prioritizations of the plurality of categories include a savings prioritization and a spending prioritization. The savings plan module 142 determines (250) the savings plan by combining the savings prioritization and the spending prioritization. The user interface module 143 displays (260) the savings plan to the user 110 through the user interface 300 as illustrated in the savings priority area 340 and the spending priority area 360. An advantage is that the utilization of the savings plan can dramatically increase the accumulation of assets for retirement and/or any other type of financial goal (e.g., college, boat, car). Another advantage is that the utilization of the savings plan can dramatically increase the time that the user's retirement funds can last through retirement by maximizing the savings in the savings priority and minimizing the spending in the spending priority.

In this example, the user's financial information 310, investment information 320, and category information 330 are utilized to prioritize the categories as illustrated in the savings priority area 340 and the spending priority area 360. The savings priority area 340 illustrates the savings prioritization that the user 110 needs to utilize to meet the projected number of years that the funds could last as illustrated in the results area of the savings plan 370. The spending priority area 360 illustrates the spending prioritization that the user 110 needs to utilize to meet the projected number of years that the funds could last as illustrated in the results area of the savings plan 370.

As another example, the savings plan module 142 generates (240) a plurality of prioritizations (e.g., savings prioritizations and spending prioritizations) based on an optimization criteria selected by the user 110. The savings plan module 142 searches for additional prioritizations and continues searching all available prioritizations until a savings plan is determined (250). The user interface module 143 displays (260) the optimal savings plan to the user 110 through the user interface 300 as illustrated in the savings priority area 340 and the spending priority area 360. In this example, the user interface 300 instructs the user 110 to spend from the categories in the following order: pre-tax exempt savings, post-tax exempt savings, post-tax deferred savings, taxable savings, and then pre-tax deferred savings.

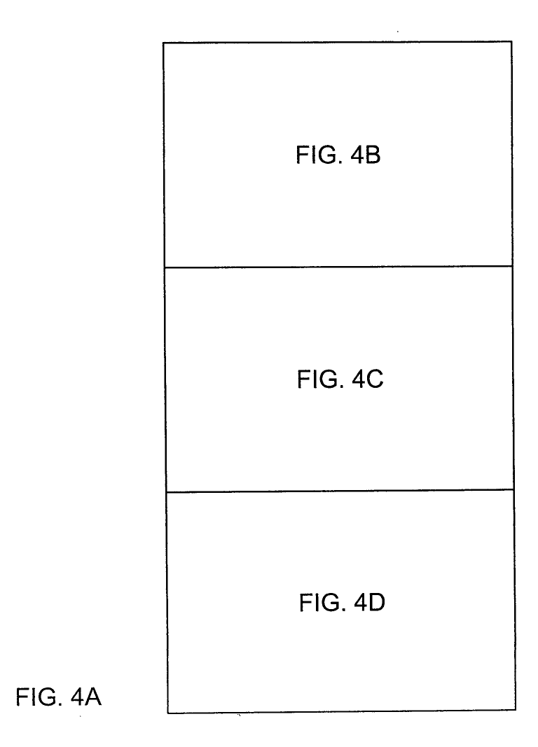

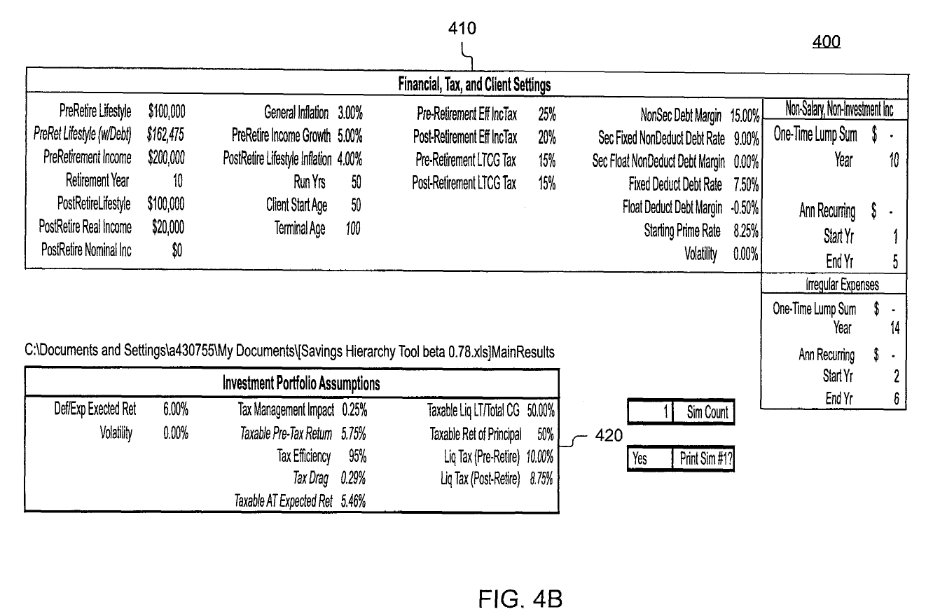

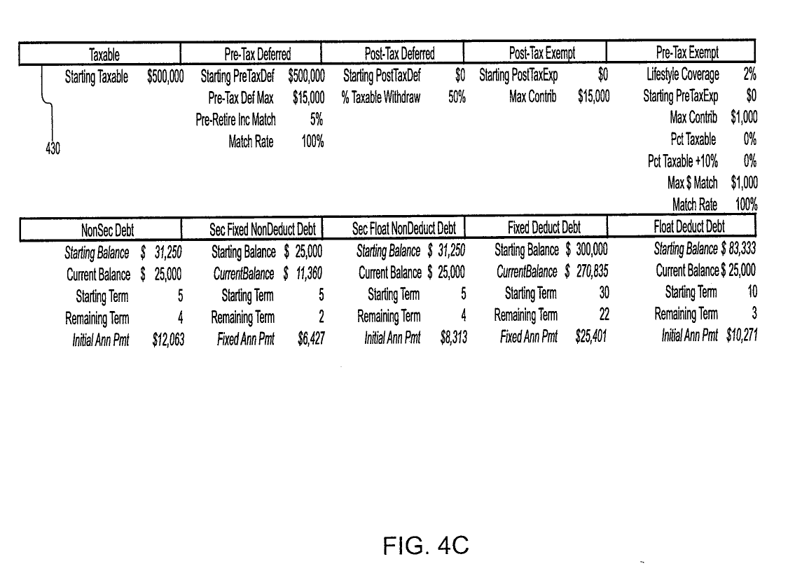

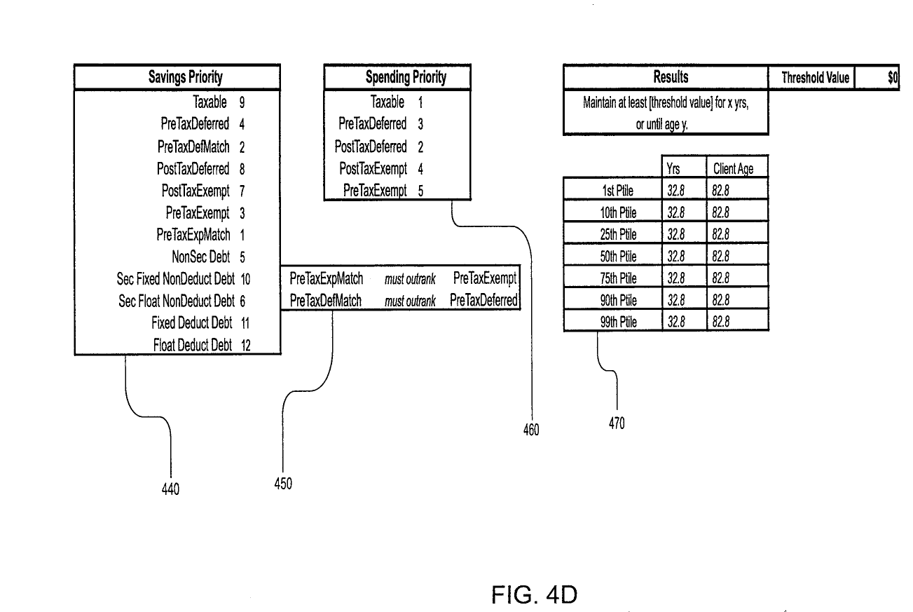

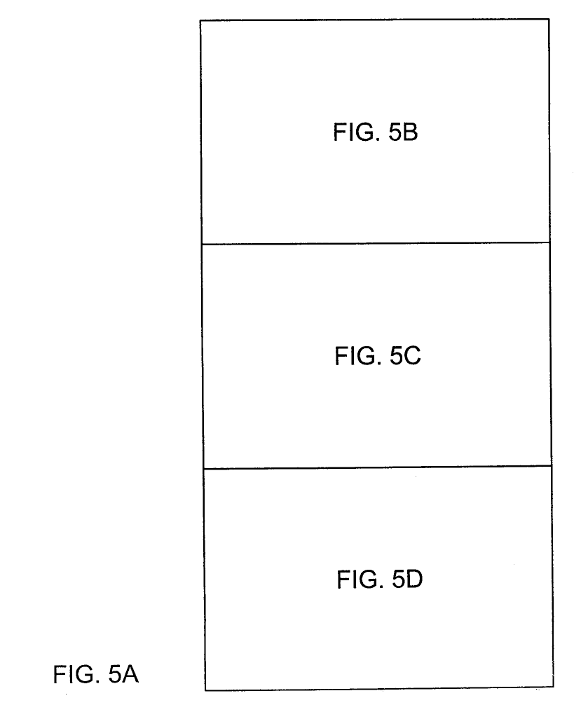

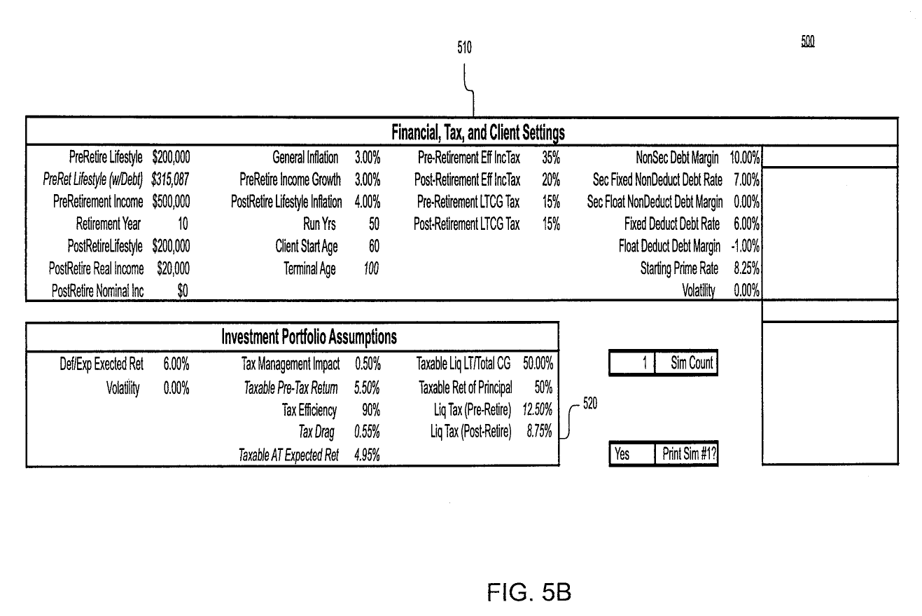

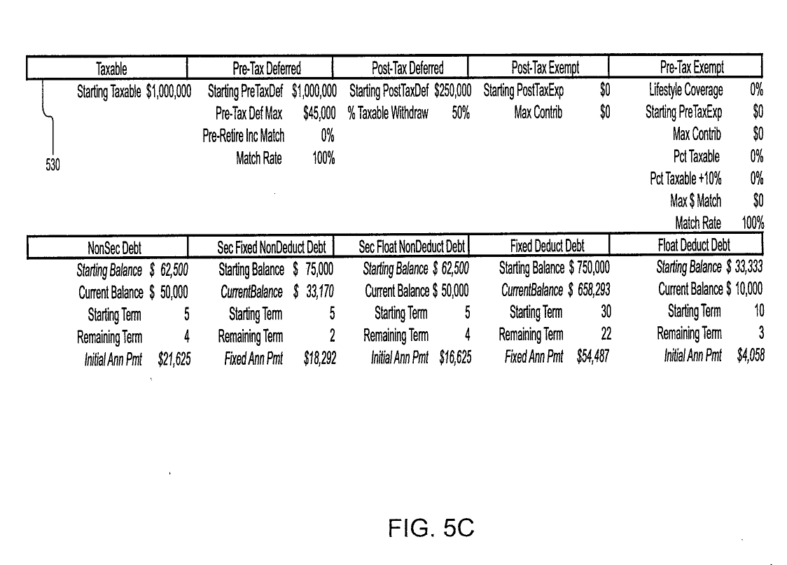

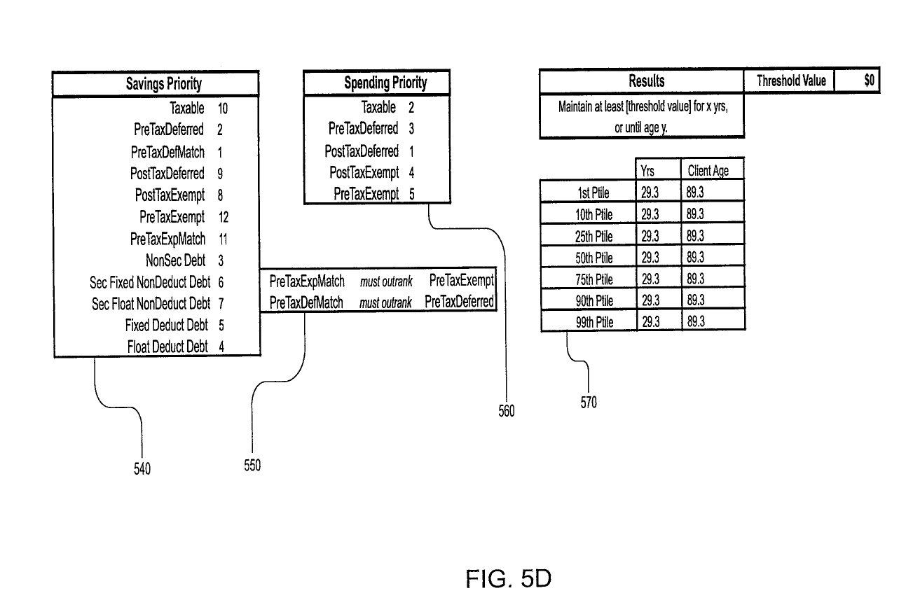

FIGS. 4 and 5 illustrate additional exemplary user interfaces 500 and 600 for different users. FIG. 4 depicts another exemplary user interface 400 of the system 100 of FIG. 1. The user interface 400 is generated by the user interface module 143. The user interface 400 includes financial information 410, investment information 420, category information 430, savings priority 440, savings priority information 450, spending priority 460, and results of the savings priority 470. The user interface 400 also includes an area for non-regular income and irregular expenses (in the upper right hand corner of FIG. 4). The non-regular income and irregular expenses area can enable, for example, the user 110 to input income (e.g., insurance payout, lottery winnings, etc.) and/or expense information (e.g., loan balloon payment, insurance deductible, etc.). FIG. 5 depicts another exemplary user interface 500 of the system 100 of FIG. 1. The user interface 500 is generated by the user interface module 143. The user interface 500 includes financial information 510, investment information 520, category information 530, savings priority 540, savings priority information 550, spending priority 560, and results of the savings priority 570.

Each of the user interfaces illustrate different savings plans based on the information inputted by each of the users. In these examples, although the categories are the same in each of the user interfaces 300, 400, and 500, the savings priorities 340, 440, and 540 have prioritizations that are different from each other because the user data is different. For example, the user associated with user interface 300 has a savings priority of 12 for the taxable category, the user associated with user interface 400 has a savings priority of 9 for the taxable category, and the user associated with user interface 500 has a savings priority of 10 for the taxable category. Accordingly, the information of each user is utilized to generate the savings prioritization and/or the spending prioritization for the savings plan. This results in a savings priority and spending priority that is optimized for that particular user.

In some examples, the user 110 utilizing the user interface (e.g., 300, 400, 500) is inputting a third party's information. The third party can be, for example, a financial client and/or any other type of individual utilizing the user 110 for financial services. The user 110 communicates the spending plan to the third party and/or changes the third party's savings and/or spending prioritization. For example, the user 110 is the third party's financial services provider and the third party has authorized the user 110 to make changes based on the savings plan. Upon generation of the savings plan, the user 110 changes the prioritization of the third party's accounts.

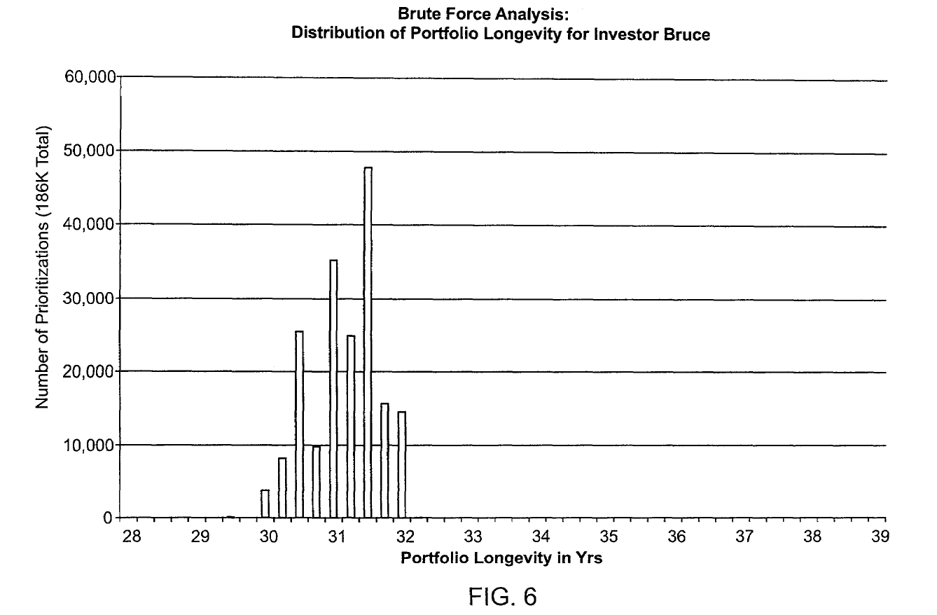

FIG. 6 depicts an exemplary distribution of portfolio longevity 600 for a given individual, as determined by the system 100 of FIG. 1 for an exemplary investor, Bruce. The exemplary distribution 600 illustrates the number of prioritizations (in this example, 186,000 prioritizations) by the portfolio longevity in years. As illustrated, there are approximately 18,000 prioritizations that provide approximately thirty two years of portfolio longevity and there are approximately 3,000 prioritizations that provide approximately thirty years of portfolio longevity. An advantage of the prioritization of the possible savings prioritizations and/or spending prioritizations in the savings plan is that the optimal savings plan can be determined from the plurality of possible savings plan (i.e., possible combinations of savings prioritizations and spending prioritizations).

### Savings Optimization

The difference, in terms of portfolio longevity, between the user's current plan and the proposed savings plan can be, for example, determined and displayed to the user 110 through a user interface (e.g., 300, 400, 500). The difference between the user's current plan the proposed savings plan is referred to as a savings optimization. For example, the savings plan module 142 determines a current savings plan. The current savings plan includes how the user 110 and/or the third party is currently saving and/or spending from the categories. The user 110 can, for example, input the current savings plan through the savings priority area 440 and spending priority area 460 of the exemplary user interface 400. In other examples, the savings plan module 142 determines the current savings plan based on the debt information, the income information, and/or the savings information which is inputted by the user 110. For example, based on the amounts of payments for debt categories and contributions for savings categories, the current prioritization of the categories can be determined.

The savings plan module 142 determines a savings optimization based on the savings plan and the current plan. The user interface module 143 generates a display of the savings optimization for display to the user 110. An advantage to the savings optimization is that the savings can be quantified and expressed in dollars (e.g., income, lump sum) and/or years (e.g., portfolio longevity, number of retirement years) for the benefit of the user.

The savings optimization can display, for example, the benefit that a change in plans would bring quantified as a time interval, such as the number of extra years during retirement for which the savings will last, the change in the number of years to save before having a predetermined amount for retirement, and/or any other type of quantifiable metric to illustrate the savings optimization. The savings optimization can display, for example in the alternative or in addition to the time interval, an amount of available funds at a certain point in time, such as a change in the amount of funds available for retirement, a change in the amount of funds available in ten years, and/or any other type of quantifiable metric to illustrate the savings optimization. The savings optimization can display any other type of metric which depicts the savings between the current prioritization and the optimized savings plan.

An advantage of the savings optimization is that the savings for the user 110 can be displayed quantitatively, thereby enabling a comparison between the user's current savings plan and the proposed savings plan. In some examples, the advantage of the savings optimization is quantified through the use of investment return: the improvement from the savings optimization can be equated to an increase in the individual's investment return.

For example, Allen Smith inputs his current plan of the savings prioritization (e.g., 340) and spending prioritization (e.g., 360) as illustrated by the user interface 300. The savings plan module 142 of FIG. 1 receives Mr. Smith's current prioritization and determines a current number of retirement years in which Mr. Smith's funds will last through retirement. Mr. Smith inputs his financial information 310, investment information 320, and category information 330 as illustrated in the user interface 300. The savings plan module 142 generates a savings plan based on this information and generates a savings optimization for Mr. Smith.

Tables 3-4 illustrate exemplary savings optimizations between Mr. Smith's current prioritization and the proposed saving plan. Tables 3-4 further illustrate that Mr. Smith can be, for example, presented with multiple savings plans which each further Mr. Smith's goals (e.g., longer retirement, more money for retirement). Tables 3-4 can be, for example, displayed as a pop-up to the exemplary user interfaces (e.g., 400 of FIG. 4, 500 of FIG. 5) and/or integrated into the exemplary user interfaces (e.g., 400 of FIG. 4, 500 of FIG. 5).

TABLE 3
Savings Optimization for Allen Smith

| | Retirement | Increase in |
|---|---|---|
| Savings Plan | Years | Years |
| Current | 23.3 years | NA |
| Proposed Plan #1 | 24.4 years | 1.1 years |
| Proposed Plan #2 | 29.3 years | 6.0 years |
| Proposed Plan #3 | 34.8 years | 11.5 years |

TABLE 4
Savings Optimization for Allen Smith

| | Amount for | Increase in |
|---|---|---|
| Savings Plan | Retirement | Amount |
| Current | $542,232.09 | NA |
| Proposed Plan #1 | $642,232.09 | $100,000.00 |
| Proposed Plan #2 | $742,232.09 | $200,000.00 |
| Proposed Plan #3 | $942,232.09 | $400,000.00 |

Tables 3-4 illustrate a plurality of proposed plans since the user 110 can utilize a variety of savings plans. For example, the user 110 does not want to save utilizing his/her company's 401K above the matching funds from the company and thus does not want to utilize the pre-tax aspect of the 401K. In this example, one of the proposed plans does not increase the savings for the 401K above the matched amount and the user 110 selects that proposed plan over another proposed plan which is better for his/her retirement account.

As another example of a savings optimization, the savings plan module 142 can determine the amount of additional funds to a given category (e.g., the a pre-tax matched savings account, a credit card account, etc.) that would be needed in order to create a given increase in portfolio longevity. Similarly, the savings plan model 142 can be used to determine, for each category, the Taxable Savings Equivalent, which is the amount of additional funds that would have to be saved into a Taxable account in order to produce the same increase in portfolio longevity as a $1,000 increase in the funds for the category in question. For example, if adding $1,000 to the Pre-Tax Deferred category produces a 1.6 year increase in portfolio longevity, and it would take an addition of $1,560 to a Taxable account to produce the same increase, then the Taxable Savings Equivalent for the Pre-Tax Deferred category is $1,560. Tables 5-6 illustrate exemplary user interfaces utilized to display the savings optimizations to the user 110. Table 5 illustrates the additional funds needed to cause a 2.1 year increase in portfolio longevity for each of two categories. Table 6 illustrates the Taxable Savings Equivalent for various categories in the individual's savings plan.

TABLE 5
Savings Optimization for Allen Smith

| | Increase | Increase in Portfolio |
|---|---|---|
| Category | Required | Longevity |
| Pre-tax deferred savings | $1,000.00 | 2.1 years |
| Post-tax savings | $1,850.00 | 2.1 years |

TABLE 6
Savings Optimization for Allen Smith

| | Amount | Taxable |
|---|---|---|
| | Increase | Savings |
| Category | per Year | Equivalent |
| Pre-tax exempt with match savings | $1,000.00 | $3,570.00 |
| Pre-tax deferred with match savings | $1,000.00 | $3,230.00 |
| Pre-tax exempt without match savings | $1,000.00 | $1,920.00 |
| Post-tax deferred savings | $1,000.00 | $1,520.00 |
| Fixed, non-deductible debt | $1,000.00 | $1,390.00 |
| Taxable savings | $1,000.00 | $1,000.00 |
| Fixed deductible debt | $1,000.00 | $880.00 |

### Accounts

A plurality of accounts can be, for example, associated with the debt information, the income information, and/or the savings information. For example, the savings information includes 401K information in which the employer matches a set percentage of the savings. The 401K information is associated with a retirement account. Table 7 illustrates exemplary accounts which are associated with categories. An advantage to the accounts is that multiple accounts can be listed under each category which reflects the different parameters for each account (e.g., two taxable savings accounts and each taxable savings account has a different interest rate).

TABLE 7
Accounts Associated with Categories

| Category | Category/Account |
|---|---|
| 1 | Secured floating non-deductable debt |
| 1A | Account: Car loan |
| 1B | Account: Second home mortgage |
| 2 | Fixed rate deductable debt |
| 2A | Account: First home mortgage |
| 2B | Account: Student loan |
| 3 | Taxable savings |
| 3A | Account: Bank money market account |
| 3B | Account: Bank savings account |
| 4 | Unsecured debt |
| 4A | Account: Credit card account |
| 4B | Account: Personal line credit account |

In some examples, the accounts are assigned to categories (e.g., as illustrated by the category information area 430 of FIG. 4). In other words, one or more accounts can be assigned to each of the categories as illustrated by Table 7. For example, the 401K information which is associated with the retirement account is assigned to the pre-tax match savings category. As another example, the 401K information which is associated with the retirement account and the investment account is assigned to the pre-tax match savings category and the savings category. Another advantage to the categories is that multiple accounts can be analyzed which enables the generation of a savings plan for individuals with diverse financial information (e.g., many accounts of various types).

### Prioritization

In the exemplary user interfaces 300, 400, and 500 described above, the savings and spending priorities listed the prioritization at the category level. When a category includes two or more accounts (e.g., as illustrated in Table 7), the accounts can be prioritized. In an illustrative example, a pre-tax match savings category can include a 401K account and a 403(b) account. The savings plan module 142 of FIG. 1 analyzes the information associated with each account to prioritize the order of each account. The 401K account has a higher match (in this example, 100%) then the 403(b) account (in this example, 50%), then the 401K account has a higher priority in the savings plan then the 403(b) account since the matching is higher (e.g., with all other factors being equal). Any of the techniques and/or examples described herein regarding the prioritization of the categories can be utilized for prioritization of the accounts in each category. The priorities of the account in each category can be, for example, identical (e.g., all accounts have the same priority), different (e.g., each account has a different order), and/or intermixed between identical and different (e.g., some accounts have the same priority and the rest of the accounts have different priorities).

Examples of the priorities of the accounts are illustrated in Tables 8-10. For example, Mr. Allen Smith has three accounts which he provides information for through the user interface 400 of FIG. 3 as illustrated in Tables 8-10.

TABLE 8
Priority for Accounts in Pre-Tax Matched Savings Category

| Priority | Account | Match Parameter |
|---|---|---|
| 1 | 401K account | 100% |
| 2 | 403(b) account | 50% |
| 3 | Health spending account | 25% |

TABLE 9
Priority for Accounts in Post-Tax Deferred Savings Category

| | | Expected Pre-Tax Return |
|---|---|---|
| Priority | Account/Investment Type | Parameter |
| 1 | Non-Qualified IRA | 8% |
| 2 | Deferred Annuity | 6% |
| 3 | US Savings Bond | 4% |

TABLE 10
Priority for Accounts in Fixed Non-Deductible Debt Category

| Priority | Account | Interest Rate Parameter |
|---|---|---|
| 1 | Second Car Loan Account | 8.75% |
| 2 | First Car Loan Account | 7.5% |
| 3 | Home Loan (Non-Qualified) | 6.75% |

Although Tables 8-10 illustrate a single parameter for the prioritization in each category, a plurality of parameters can be utilized to prioritize the accounts in each category. For example, in Table 10, the amount, term, and the interest rate for each account can be utilized to determine the prioritization of the accounts in the category. These parameters are often needed in order assign priority to accounts within a category.

The savings plan module 142 can determine, for example, an optimal prioritization from the plurality of prioritizations (e.g., all possible sequences of prioritizations, a set of prioritizations, etc.) based on a selection criteria. The selection criteria can include, for example, retirement income amount, portfolio longevity in retirement, portfolio value at retirement, and/or many other types of financial criteria. For example, there are twelve categories (as illustrated in Table 1 above) with assigned accounts. As such, there are a plurality of prioritizations for the twelve categories (in this example, approximately 480 million possible permutations with twelve categories). The optimal prioritization for the user 110 is determined based on the selection criteria (in this example, lump sum amount). As such, the savings plan module 142 determines a savings plan in which the twelve categories are prioritized to maximum the portfolio value for the user 110 at the set time (in this example, the set time that the user 110 wants to retire—in forty-five years). Tables 11-12 illustrate the prioritization of twelve categories based on portfolio value and portfolio duration, respectively.

TABLE 11
Savings Plans to Maximize Portfolio Value at Retirement

| | | Portfolio |
|---|---|---|
| | | Value at |
| Plan # | Savings Plan - Category Rankings | Retirement |
| 1 | (1) Pre-Tax Deferred with Match, (2) Pre-Tax Exempt with Match, (3) | $2,450,234 |
| | Unsecured Debt, (4) Secured Fixed-Rate Non-Deductible Debt, (5) Pre-Tax | |
| | Exempt, (6) Post-Tax Exempt, (7) Pre-Tax Deferred, (8) Post-Tax | |
| | Deferred, (9) Taxable, (10) Floating Rate Deductible Debt, (11) Secured | |
| | Floating-Rate Deductible Debt), (12) Fixed-Rate Deductible Debt | |
| 2 | (1) Pre-Tax Deferred with Match, (2) Pre-Tax Exempt with Match, (3) | $2,437,803 |
| | Secured Fixed-Rate Non-Deductible Debt, (4) Unsecured Debt, (5) Pre-Tax | |
| | Exempt, (6) Post-Tax Exempt, (7) Pre-Tax Deferred, (8) Post-Tax | |
| | Deferred, (9) Taxable, (10) Floating Rate Deductible Debt, (11) Secured | |
| | Floating-Rate Deductible Debt), (12) Fixed-Rate Deductible Debt | |
| 3 | (1) Pre-Tax Deferred with Match, (2) Secured Fixed-Rate Non-Deductible | $2,420,438 |
| | Debt, (3) Pre-Tax Exempt with Match, (4) Unsecured Debt, (5) Pre-Tax | |
| | Exempt, (6) Post-Tax Exempt, (7) Pre-Tax Deferred, (8) Post-Tax | |
| | Deferred, (9) Taxable, (10) Floating Rate Deductible Debt, (11) Secured | |
| | Floating-Rate Deductible Debt), (12) Fixed-Rate Deductible Debt | |

TABLE 12
Priority for Categories to Maximize Duration for Retirement

| | | Portfolio |
|---|---|---|
| | | Longevity in |
| Plan # | Savings Plan - Category Rankings | Retirement |
| 2 | (1) Pre-Tax Deferred with Match, (2) Pre-Tax Exempt with Match, (3) | 34.3 years |
| | Secured Fixed-Rate Non-Deductible Debt, (4) Unsecured Debt, (5) Pre- | |
| | Tax Exempt, (6) Post-Tax Exempt, (7) Pre-Tax Deferred, (8) Post-Tax | |
| | Deferred, (9) Taxable, (10) Floating Rate Deductible Debt, (11) Secured | |
| | Floating-Rate Deductible Debt), (12) Fixed-Rate Deductible Debt | |
| 3 | (1) Pre-Tax Deferred with Match, (2) Secured Fixed-Rate Non- | 32.0 years |
| | Deductible Debt, (3) Pre-Tax Exempt with Match, (4) Unsecured Debt, | |
| | (5) Pre-Tax Exempt, (6) Post-Tax Exempt, (7) Pre-Tax Deferred, (8) | |
| | Post-Tax Deferred, (9) Taxable, (10) Floating Rate Deductible Debt, (11) | |
| | Secured Floating-Rate Deductible Debt), (12) Fixed-Rate Deductible | |
| | Debt | |
| 1 | (1) Pre-Tax Deferred with Match, (2) Pre-Tax Exempt with Match, (3) | 29.2 years |
| | Unsecured Debt, (4) Secured Fixed-Rate Non-Deductible Debt, (5) Pre- | |
| | Tax Exempt, (6) Post-Tax Exempt, (7) Pre-Tax Deferred, (8) Post-Tax | |
| | Deferred, (9) Taxable, (10) Floating Rate Deductible Debt, (11) Secured | |
| | Floating-Rate Deductible Debt), (12) Fixed-Rate Deductible Debt | |

In some examples, the categories include pre-tax deferred matched savings (e.g., 401K, 403(b), 457(b) with an employer match), unsecured debt (e.g., credit card balances, personal loans), pre-tax exempt matched savings (e.g., health spending accounts with an employer match), secured floating non-deductible debt, pre-tax exempt unmatched savings (e.g., health spending accounts without an employer match), pre-tax deferred unmatched savings (e.g., 401K without an employer match), post-tax exempt savings (e.g., 529 plans), secured fixed non-deductible debt (e.g., auto loans, marine loans), post-tax deferred savings (e.g., variable annuities), taxable savings (e.g., bank savings accounts, bank money market accounts, brokerage accounts), and fixed rate deductible debt (e.g., fixed-rate home mortgage). The categories are illustrated in the category information area 330 of FIG. 3.

### Prioritization Techniques

To generate prioritizations (e.g., step 240 of FIG. 2) and/or to determine the savings plan (e.g., step 250 of FIG. 2), the spending plan module 142 can utilize, for example, a Formulaic prioritization technique, a Winnowing prioritization technique, or an Isolate-and-Test prioritization technique. The savings plan module 142 can utilize, for example, one or more prioritization techniques as described below to create the savings prioritization and/or the spending prioritization. Further, one technique can be used as a comparison point for another technique. For example, the savings plan module 142 utilizes the formulaic prioritization technique as described below to generate a savings plan for John Allen and then the savings plan module 142 utilizes the complete prioritization technique as described below to check that the savings plan generated by the formulaic prioritization is the optimal savings plan.

Formulaic Prioritization

In some examples, the system utilizes financial properties of the categories and relationships between them to prioritize the categories. The financial properties include, for example, a pre-defined formula relating the categories to each other (e.g., each category has a pre-defined weight in a formula), a dynamically generated formula relating the categories to each other (e.g., each category has a dynamically generated weight in a formula based on the information for the category), and/or any other type of formula that is based on the inter-relationships between the categories (e.g., interest rate, balance, term, etc.). The prioritization based on the financial properties between the categories advantageously provides for the generation of savings and/or spending prioritizations to be solved nearly simultaneously with each other which decreases the time needed to generate the prioritization of the categories and/or accounts.

Winnowing Prioritization

In other examples, the savings plan module 142 generates an optimal prioritization of the categories based on an evaluation of all possible prioritizations after eliminating as many prioritizations as possible—hence winnowing—through the use of a set of one or more business rules. The business rules include, for example, a rule that Pre-Tax Deferred with a match accounts always precede similar accounts without a match, because the former area always preferable and therefore would always rank more highly in an optimal prioritization. Therefore, any prioritization that includes one or more Unmatched Pre-Tax Deferred accounts before one or more Matched Pre-Tax Deferred accounts need not be analyzed, because the rule guarantees that it cannot be optimal.

The business rules are utilized to exclude prioritizations that will not benefit the user 110 without having to analyze each of the possible prioritizations (e.g., millions of possible prioritizations). Since the number of possible of prioritizations that remain after all of the business rules have been applied is usually a small fraction of the original number, which can then exhaustively analyzed, the business rules make it possible to apply the winnowing prioritization in many instances.

For example, for a user 110 with accounts in twelve categories, there are over 480 million permutations of the categories. The user 110 wants to optimize the savings plan for portfolio longevity. In this instance, the application of the business rules reduces the number of permutations to approximately 200,000. At this point, the winnowing prioritization has advantageously made it possible to analyze all of the prioritization candidates in a reasonable amount of time.

Isolate and Test Prioritization

The savings plan module 142 can prioritize each category in the plurality of categories independently of the other categories (in other words, each category is isolated and tested). For example, the savings plan module 142 assigns an arbitrary amount of additional funds to each category from #1 through #12, independently of the other categories. The savings plan module 142 then measures the resulting changes to determine which category has the greatest effect on the objective (e.g., portfolio longevity, portfolio balance at retirement). The savings plan module 142 determines which category has the greatest effect and gives that category priority over those accounts with less effect. For example, if the pre-tax deferred with a match category has the greatest effect on the overall portfolio (e.g., increases retirement time 0.6 years more than any other category), then the pre-tax deferred with a match category is prioritized as the first category in the prioritization.

Complete Prioritization of Categories

Each prioritization for the categories can be, for example, determined and compared with each other to determine the savings plan. In other words, the prioritization that optimizes the user's objectives (e.g., more money, more time) is selected as the savings plan.

### Information

The information received by the savings plan module 142 of FIG. 1 can include, for example, financial information (e.g., illustrated by the financial information area 310 of FIG. 3), investment information (e.g., illustrated by the investment information area 320), category information (e.g., illustrated by the category information area 330), savings priority (e.g., illustrated by the savings information area 340), savings priority information (e.g., illustrated by the savings priority information area 350), and/or any other type of financial information. The information can be, for example, inputted by the user 110 through a user interface (e.g., 400 of FIG. 4). The information areas 510, 520, and 530 of FIG. 5 illustrate the information received by the savings plan module 142.

In some examples, the information received by the savings plan module 142 can include, for example, debt information, income information, savings information, and/or any other type of financial information. The debt information can include, for example, a credit card account, a loan account, a non-secured debt account (e.g., illustrated by the non-secured debt information in the category information area 430), a secured fixed non-deductible debt account (e.g., illustrated by the secured fixed non-deductible debt information in the category information area 430), a secured floating non-deductible debt account (e.g., illustrated by the secured floating non-deductible debt information in the category information area 430), a fixed deductible debt account (e.g., illustrated by the fixed deductible debt information in the category information area 430), a floating deductible debt account (e.g., illustrated by the floating deductible debt information in the category information area 430), and/or any other type of debt information.

The savings information can include, for example, a retirement account, an investment account, a pre-tax deferred savings account (e.g., illustrated by the pre-tax deferred information in the category information area 330), a post-tax deferred savings account (e.g., illustrated by the post-tax deferred savings information in the category information area 330), a post-tax exempt savings account (e.g., illustrated by the post-tax exempt savings information in the category information area 330), a pre-tax exempt savings account (e.g., illustrated by the pre-tax exempt savings information in the category information area 330), and/or any other type of savings information.

In some examples, the information includes retirement information (e.g., illustrated by the financial information area 310 of FIG. 3—post retirement lifestyle $55,000, post retirement real income $0, retirement year thirty years). The retirement information can include, for example, an age (e.g., twenty-five, thirty), a retirement age (e.g., sixty-five, forty-five), investment criteria (e.g., conservative, growth), insurance information (e.g., annuity, health insurance), and/or any other type of retirement information.

In other examples, the information includes tax information (e.g., as illustrated by the financial information area 310—pre-retirement effective income tax 20%, post-retirement effective income tax 25%). The tax information can include, for example, a tax bracket (e.g., 28%, current tax bracket, expected tax bracket upon retirement), a deduction (e.g., current deductions, deductions upon retirement), an effective tax rate, and/or any other type of tax information.

The information (e.g., illustrated by the user interface 300) can be, for example, received from a third party server (e.g., tax preparation server, bank server) and/or a third party software package (e.g., financial accounting software, tax preparation software). The information can be received, for example, from a plurality of user interfaces. For example, the financial planner could input the information regarding the user's information associated with the financial planner and the user could input the rest of the information.

The above-described systems and methods can be implemented in digital electronic circuitry, in computer hardware, firmware, and/or software. The implementation can be as a computer program product (i.e., a computer program tangibly embodied in an information carrier). The implementation can, for example, be in a machine-readable storage device, for execution by, or to control the operation of, data processing apparatus. The implementation can, for example, be a programmable processor, a computer, and/or multiple computers.

A computer program can be written in any form of programming language, including compiled and/or interpreted languages, and the computer program can be deployed in any form, including as a stand-alone program or as a subroutine, element, and/or other unit suitable for use in a computing environment. A computer program can be deployed to be executed on one computer or on multiple computers at one site.

Method steps can be performed by one or more programmable processors executing a computer program to perform functions of the invention by operating on input data and generating output. Method steps can also be performed by and an apparatus can be implemented as special purpose logic circuitry. The circuitry can, for example, be a FPGA (field programmable gate array) and/or an ASIC (application-specific integrated circuit). Modules, subroutines, and software agents can refer to portions of the computer program, the processor, the special circuitry, software, and/or hardware that implements that functionality.

Processors suitable for the execution of a computer program include, by way of example, both general and special purpose microprocessors, and any one or more processors of any kind of digital computer. Generally, a processor receives instructions and data from a read-only memory or a random access memory or both. The essential elements of a computer are a processor for executing instructions and one or more memory devices for storing instructions and data. Generally, a computer can include, can be operatively coupled to receive data from and/or transfer data to one or more mass storage devices for storing data (e.g., magnetic, magneto-optical disks, or optical disks).

Data transmission and instructions can also occur over a communications network. Information carriers suitable for embodying computer program instructions and data include all forms of non-volatile memory, including by way of example semiconductor memory devices. The information carriers can, for example, be EPROM, EEPROM, flash memory devices, magnetic disks, internal hard disks, removable disks, magneto-optical disks, CD-ROM, and/or DVD-ROM disks. The processor and the memory can be supplemented by, and/or incorporated in special purpose logic circuitry.

To provide for interaction with a user, the above described techniques can be implemented on a computer having a display device. The display device can, for example, be a cathode ray tube (CRT) and/or a liquid crystal display (LCD) monitor. The interaction with a user can, for example, be a display of information to the user and a keyboard and a pointing device (e.g., a mouse or a trackball) by which the user can provide input to the computer (e.g., interact with a user interface element). Other kinds of devices can be used to provide for interaction with a user. Other devices can, for example, be feedback provided to the user in any form of sensory feedback (e.g., visual feedback, auditory feedback, or tactile feedback). Input from the user can, for example, be received in any form, including acoustic, speech, and/or tactile input.

The above described techniques can be implemented in a distributed computing system that includes a back-end component. The back-end component can, for example, be a data server, a middleware component, and/or an application server. The above described techniques can be implemented in a distributing computing system that includes a front-end component. The front-end component can, for example, be a client computer having a graphical user interface, a Web browser through which a user can interact with an example implementation, and/or other graphical user interfaces for a transmitting device. The components of the system can be interconnected by any form or medium of digital data communication (e.g., a communication network). Examples of communication networks include a local area network (LAN), a wide area network (WAN), the Internet, wired networks, and/or wireless networks.

The system can include clients and servers. A client and a server are generally remote from each other and typically interact through a communication network. The relationship of client and server arises by virtue of computer programs running on the respective computers and having a client-server relationship to each other.

Packet-based communication networks can include, for example, the Internet, a carrier internet protocol (IP) network (e.g., local area network (LAN), wide area network (WAN), campus area network (CAN), metropolitan area network (MAN), home area network (HAN)), a private IP network, an IP private branch exchange (IPBX), a wireless network (e.g., radio access network (RAN), 802.11 network, 802.16 network, general packet radio service (GPRS) network, HiperLAN), and/or other packet-based networks. Circuit-based networks can include, for example, the public switched telephone network (PSTN), a private branch exchange (PBX), a wireless network (e.g., RAN, bluetooth, code-division multiple access (CDMA) network, time division multiple access (TDMA) network, global system for mobile communications (GSM) network), and/or other circuit-based networks.

The transmitting device can include, for example, a computer, a computer with a browser device, a telephone, an IP phone, a mobile device (e.g., cellular phone, personal digital assistant (PDA) device, laptop computer, electronic mail device), and/or other communication devices. The browser device includes, for example, a computer (e.g., desktop computer, laptop computer) with a world wide web browser (e.g., Microsoft® Internet Explorer® available from Microsoft Corporation, Mozilla® Firefox available from Mozilla Corporation). The mobile computing device includes, for example, a personal digital assistant (PDA).

Comprise, include, and/or plural forms of each are open ended and include the listed parts and can include additional parts that are not listed. And/or is open ended and includes one or more of the listed parts and combinations of the listed parts.

One skilled in the art will realize the invention may be embodied in other specific forms without departing from the spirit or essential characteristics thereof. The foregoing embodiments are therefore to be considered in all respects illustrative rather than limiting of the invention described herein. Scope of the invention is thus indicated by the appended claims, rather than by the foregoing description, and all changes that come within the meaning and range of equivalency of the claims are therefore intended to be embraced therein.

What is claimed is:

1. A computerized method for generating a savings plan, the method comprising:
receiving debt information, income information, and savings information;
receiving retirement information, the retirement information comprising an age, a retirement age, investment criteria, insurance information, or any combination thereof;
assigning the debt information, the income information, and the savings information to a plurality of categories; and
automatically generating the savings plan by prioritizing the assigned plurality of categories based on the debt information, the income information, the savings information, the retirement information, or any combination thereof.

2. The method of claim 1, further comprising providing a user interface to enable a user to enter information.

3. The method of claim 1, further comprising generating a display which comprises the savings plan.

4. The method of claim 1, further comprising:
determining a current plan of the assigned plurality of categories based on the debt information, the income information, the savings information, or any combination thereof; and
determining a savings optimization based on the savings plan and the current plan.

5. The method of claim 4, further comprising generating a display which comprises the savings optimization.

6. The method of claim 4, wherein the savings optimization comprises a time interval, an amount, or both.

7. The method of claim 1, further comprising associating a plurality of accounts with the debt information, the income information, the savings information, or any combination thereof.

8. The method of claim 7, further comprising assigning the plurality of accounts to the plurality of categories.

9. The method of claim 8, further comprising, in each category which comprises a plurality of accounts, prioritizing the plurality of accounts within the category.

10. The method of claim 8, wherein a priority for each account in a first category are identical.

11. The method of claim 8, wherein a priority for each account in a first category are different.

12. The method of claim 1, further comprising determining an optimal prioritization of the assigned plurality of categories based on a selection criteria.

13. The method of claim 12, further comprising determining the selection criteria based on retirement income amount, portfolio longevity in retirement, portfolio value at retirement, or any combination thereof.

14. The method of claim 1, wherein the automatically generating comprises prioritizing the assigned plurality of categories based on the debt information, the income information, the savings information, or any combination thereof and relationships between financial properties of the assigned plurality of categories.

15. The method of claim 1, wherein the automatically generating comprises prioritizing the assigned plurality of categories based on the debt information, the income information, the savings information, the tax information, or any combination thereof and a set of savings plans.

16. The method of claim 15, further comprising determining the set of savings plans by utilizing one or more business rules with the debt information, the income information, the savings information, or any combination thereof, each savings plan in the set of savings plans comprises a prioritization, which is different from prioritizations of other savings plans in the set of savings plans, and the set of savings plans comprises fewer prioritizations then possible for the assigned plurality of categories.

17. The method of claim 15, further comprising determining the set of savings plans based on a client category.

18. The method of claim 17, further comprising determining the client category by prioritizing one or more client parameters associated with the debt information, the income information, the savings information, or any combination thereof.

19. The method of claim 1, wherein the prioritizing the debt information, the income information, and the savings information based on the assigned plurality of categories further comprises prioritizing the debt information, the income information, and the savings information in each assigned category independently from other categories in the assigned plurality of categories based on the assigned plurality of categories.

20. The method of claim 1, wherein the plurality of categories comprises income, taxable savings, pre-tax deferred matched savings, unsecured debt, pre-tax exempt matched savings, pre-tax exempt non-matched savings, pre-tax deferred non-matched savings, post-tax exempt savings, post-tax deferred savings, secured floating non-deductible debt, secured fixed non-deductible debt, fixed rate deductible debt, or any combination thereof.

21. The method of claim 1, wherein the debt information comprises a credit account, a loan account, a non-secured debt account, a secured fixed non-deductible debt account, a secured floating non-deductible debt account, a fixed deductible debt account, a floating deductible debt account, or any combination thereof.

22. The method of claim 1, wherein the savings information comprises a retirement account, an investment account, a pre-tax deferred savings account, a post-tax deferred savings account, a post-tax exempt savings account, a pre-tax exempt savings account, or any combination thereof.

23. The method of claim 1, further comprising receiving tax information, the tax information comprising a tax bracket, a deduction, an effective tax rate, or any combination thereof.

24. A computer program product, tangibly embodied in an information carrier, the computer program product including instructions being operable to cause a data processing apparatus to:
receive debt information, income information, and savings information;
receive retirement information, the retirement information comprising an age, a retirement age, investment criteria, insurance information, or any combination thereof;
assign the debt information, the income information, and the savings information to a plurality of categories; and
automatically generate the savings plan by prioritizing the assigned plurality of categories based on the debt information, the income information, the savings information, the tax information, the retirement information, or any combination thereof.

25. A system for generating a savings plan, the system comprising:
a savings plan module configured to:
receive debt information, income information, savings information, and receive retirement information, the retirement information comprising an age, a retirement age, investment criteria, insurance information, or any combination thereof,
assign the debt information, the income information, and the savings information to a plurality of categories, and
automatically generate the savings plan by prioritizing the assigned plurality of categories based on the debt information, the income information, the savings information, or any combination thereof.

26. The system of claim 22, further comprising:
an information storage module configured to store the retirement information, the debt information, the income information, and the savings information.

27. A system for generating a savings plan, the system comprising:
a means for receiving debt information, income information, savings information, tax information, and receive retirement information, the retirement information comprising an age, a retirement age, investment criteria, insurance information, or any combination thereof,
a means for assigning the debt information, the income information, and the savings information to a plurality of categories, and
a means for automatically generating the savings plan by prioritizing the assigned plurality of categories based on the debt information, the income information, the savings information, the tax information, or any combination thereof.
